(19) United States
(12) Patent Application Publication
(10) Pub. No.: US 2023/0117701 A1
(43) Pub. Date: Apr. 20, 2023

(54) CARRYING CASE OR BAG

(71) Applicant: Joseph A. Tardio, Rutherford, NJ (US)

(72) Inventor: Joseph A. Tardio, Rutherford, NJ (US)

(21) Appl. No.: 17/967,979

(22) Filed: Oct. 18, 2022

Related U.S. Application Data
(60) Provisional application No. 63/257,162, filed on Oct. 19, 2021.

(51) Int. Cl. A45C 7/00; G10G 7/00

(52) U.S. Cl. CPC A45C 7/0027; G10G 7/005

(57) ABSTRACT

An expandable carrying case comprises first and second compartments. The first compartment includes a plurality of first walls forming a first space therebetween. A first opening is positioned on one of the plurality of first walls. The first opening is configured to be opened for access to the first space, and also configured to be closed to enclose the first space. The second compartment is coupled to the first compartment and configured to be stored within the first compartment to a stored state, and also configured to extend from the first compartment to an extended state. The second compartment includes a plurality of second walls forming a second space therebetween. A second opening is positioned on one of the plurality of second walls. The second opening is configured to be opened for access to the second space, and also configured to be closed.

### CROSS REFERENCE TO RELATED APPLICATION

This application claims priority to U.S. Provisional Application No. 63/257,162 titled “Collapsible Guitar and Carrying Cases Therefor,” filed on Oct. 19, 2021, which is incorporated by reference herein in its entirety.

### FIELD

The present invention relates to carrying cases or bags, and more particularly to an expandable carrying case or bag.

### BACKGROUND

The guitar has been a popular instrument for individuals of all age groups and for people with different skill levels. Guitars are normally stored in a case for transport. Most cases that are capable of protecting the guitar from damage during transport are heavily padded and insulated, thus making the case quite bulky. Often times storing and transporting guitars is problematic due to the size of the guitar and its case. For example, individuals with small automobiles may not have sufficient space in a trunk or on a seat for a guitar case. As another example, it is not possible to carry the guitar and the case it is stored in onto an airplane because the dimensions exceed the maximum dimensions allowed for carryon luggage. Currently, the maximum dimensions for carryon luggage for U.S. domestic airlines range between 22 inches × 14 inches × 9 inches, and 24 inches × 17 inches × 10 inches.

Collapsible guitars exist in the prior art. However, such guitars, even when collapsed exceed the dimensions allowed by U.S. domestic airlines for carrying onto an airplane.

Smaller guitars, for example, mini guitars exist in the prior art. These guitars are often used by younger players or as practice guitars for older players. However, even mini guitars and cases for the same are too large for carrying onto an airplane. Moreover, a certain number of mini guitars in the prior art are not collapsible because the components thereof are required to be assembled for permanent construction due to the distinct nature of their construction and assembly. Mini guitars that are collapsible often have complicated systems to fold the guitar that more often than not create tuning stability issues and/or add significant weight and complexity. Furthermore, collapsible mini guitars in the prior art exceed the maximum dimensions for carryon luggage for U.S. domestic airlines.

Therefore, a need exists for a collapsible guitar that is capable of quick and easy disassembly, and also capable of quick and easy assembly, of which tuning stability and overall weight of the instrument is not adversely affected. A need also exists for a compact carrying case for a collapsible guitar.

Even though expandable cases or bags exist in the prior art, they are only expandable in depth. That is, such cases or bags are provided with a zipper that circumscribes the top wall, bottom wall, left side wall and right side wall of the case or bag. The zipper is opened to provide slightly more depth within the case or bag. However, a user may need extra length, for example to accommodate objects that are longer than the normal length of the case or bag.

As discussed above, the prior art lacks a case or bag that is expandable in length, let alone such a case or bag that includes an easily accessible compartment within the expandable length. Such compartment would be convenient to store items that are needed often during travel, e.g., wallets, keys, purses, passports, make-up, beverages, hand-held devices, etc.

Therefore, a need exists for a case or bag that is expandable in length and such case or bag with an easily accessible auxiliary storage compartment.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The collapsible guitar of the present invention solves the problems of the prior art and provides additional advantages. The collapsible guitar of the present invention is capable of quick and easy disassembly, and also capable of quick and easy assembly. Moreover, the collapsible guitar of the present invention is configured and dimensioned to be capable of being stored and transported as carrying-on luggage on flights.

The expandable carrying case or bag of the present invention provides a compact carrying case for a guitar that is capable of secure storage and transport as carry-on luggage. The carrying case or bag of the present invention also provides a secure storage and transport means for any item or object, and accommodates longer items or objects by being expandable in length. In addition, the carrying case or bag of the present invention provides an easily accessible auxiliary storage compartment.

In one aspect, the present invention provides an expandable carrying case comprising: a first compartment having: a plurality of first walls forming a first space therebetween; and a first opening positioned on one of the plurality of first walls, the first opening configured to be opened for access to the first space, and configured to be closed to enclose the first space; and a second compartment coupled to the first compartment and configured to be stored within the first compartment to a stored state, and configured to extend from the first compartment to an extended state, the second compartment having: a plurality of second walls forming a second space therebetween; and a second opening positioned on one of the plurality of second walls, the second opening configured to be opened for access to the second space, and configured to be closed, the first and second openings being substantially aligned with each other; wherein in the extended state, the second compartment extends through the first opening, and the first and second spaces are adjacent to each other thereby forming a collective third space, the third space being enclosed when the second opening is closed; and wherein in the stored state, the second space is positioned within the first space, the second space at least partially coinciding with the first space such that an object is free to move within the first and second spaces and through the first opening.

In another aspect, the present invention provides an expandable carrying case comprising: a first compartment having: a plurality of first walls forming a first space therebetween; and a first opening positioned on one of the plurality of first walls, the first opening configured to be opened for access to the first space, and configured to be closed to enclose the first space; and a second compartment coupled to the first compartment and configured to be stored within the first compartment to a stored state, and configured to extend from the first compartment to an extended state, the second compartment having: a plurality of second walls forming a second space therebetween; and a second opening positioned on one of the plurality of second walls, the second opening configured to be opened for access to the second space, and configured to be closed; wherein in the extended state, the second compartment extends through the first opening, and the first and second spaces are adjacent to each other thereby forming a collective third space, the third space being enclosed when the second opening is closed; and wherein in the stored state, the second space is positioned within the first space.

In yet another aspect, the present invention provides an expandable carrying case comprising: a first compartment having: a plurality of first walls forming a first space therebetween; and a first opening positioned on one of the plurality of first walls, the first opening configured to be opened for access to the first space, and configured to be closed to enclose the first space; and a second compartment coupled to the first compartment and configured to be stored within the first compartment to a stored state, and configured to extend from the first compartment to an extended state, the second compartment having: a plurality of second walls forming a second space therebetween; and a second opening positioned on one of the plurality of second walls, the second opening configured to be opened for access to the second space, and configured to be closed.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a front view of a first embodiment of a collapsible guitar of the present invention;

FIG. 2 shows a rear review of the collapsible guitar of FIG. 1;

FIG. 3 shows a rear view of a second embodiment of a collapsible guitar of the present invention, i.e., a full sized collapsible guitar;

FIG. 4 shows a front perspective view of an embodiment of an expandable carrying case or bag with a first compartment in a closed state, and superimposed with a collapsed guitar stored thererin;

Fib. 5 shows the carrying case or bag of FIG. 4 with the first compartment in an opened state with the collapsed guitar partially removed therefrom;

FIG. 6 shows the carrying case or bag of FIG. 4 with a second compartment partially extending from the first compartment;

FIG. 7 shows the carrying case or bag of FIG. 4 with the second compartment fully expanded, and superimposed with a fully assembled guitar stored therein;

FIG. 8 the carrying case or bag of FIG. 7 with the second compartment fully closed;

FIG. 9 shows a rear perspective view of the carrying case or bag of FIG. 8;

FIG. 10A shows a front perspective view of the carrying case or bag of FIG. 4 with the second compartment in a stored state, and superimposed with the first compartment;

FIG. 10B shows the carrying case or bag of FIG. 10A with the second compartment partially extending from the first compartment, and superimposed therewith;

FIG. 10C shows the carrying case or bag of FIG. 10A with the second compartment fully extended from the first compartment in an extended state, and superimposed therewith; and

FIG. 10D shows the carrying case or bag of FIG. 10A with the second compartment partially collapsed into the first compartment, and superimposed therewith.

To facilitate an understanding of the invention, identical reference numerals have been used, when appropriate, to designate the same or similar elements that are common to the figures. Further, unless stated otherwise, the features shown in the figures are not drawn to scale and are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

### Guitar

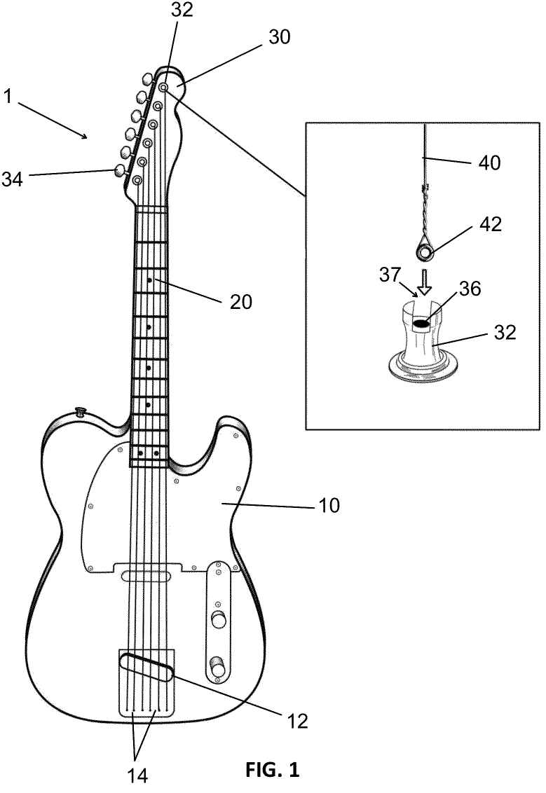

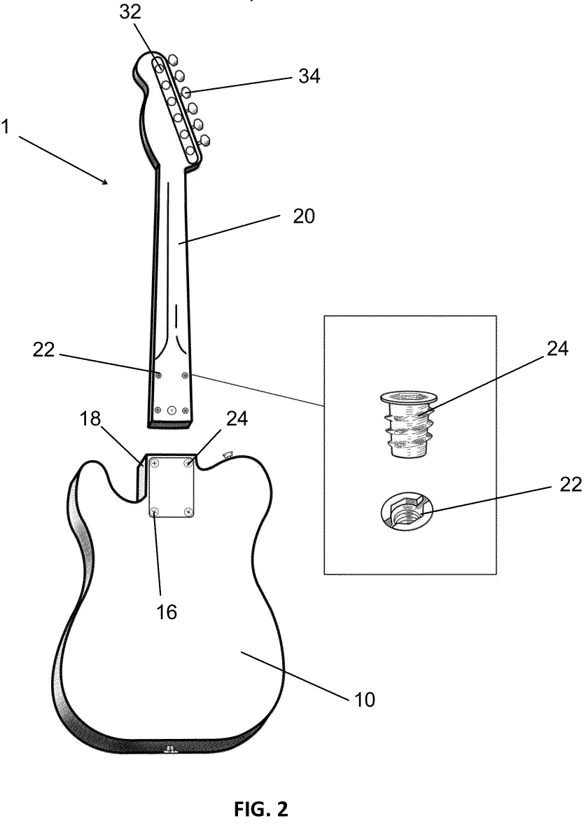

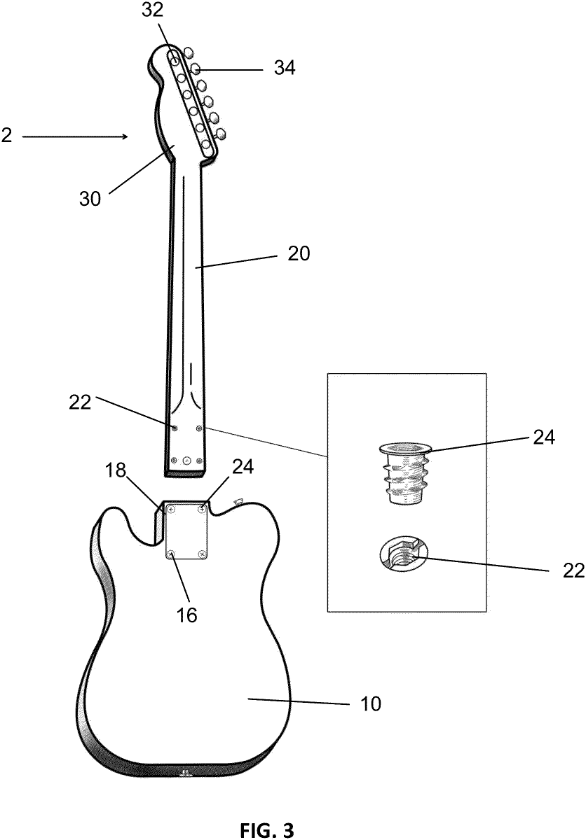

Referring to FIGS. 1-3, embodiments of a collapsible guitar 1, 2 of the present invention are shown. Specifically, in a first embodiment as shown in FIGS. 1 and 2, the guitar 1 is a mini guitar having approximately 12 frets, less frets than traditional guitars, while in a second embodiment as shown in FIG. 3, the guitar 2 includes the usual number of frets as other traditional guitars i.e., 21 to 24 frets. In each embodiment, an electric guitar is shown but the present invention is not limited thereto. The present invention could be embodied in acoustic guitars as well.

The mini guitar 1 of the present invention is manufactured to meet the three most common scale lengths of traditional guitars, i.e., 24.75″, 25″ and 25.5″, by adjusting the position of the bridge 12 on the body 10 and/or changing the distance between frets on the neck 20 and/or the fretboard. As such, the mini guitar 1 could be played with the same qualities as a traditional guitar.

Still referring to FIGS. 1-3, the guitar 1, 2 includes a body 10 attached to a neck 20. A front side of the body 10 includes a bridge 12 having bridge pins 14 positioned at or near a lower end of the body 10. Strings are secured to the bridge pins 14 by conventional means known in the prior art. A front side of the body 10 includes a rectangular cutout 18 having threaded apertures 16 at an upper end of the body 10 extended partially therethrough. The rectangular cutout 18 is sized and shaped such that a lower end of the neck 20 is capable of being positioned therein snugly while providing an even top outer surface between the body 10 and neck 20 when assembled.

Referring to FIGS. 2 and 3, a rear side of the neck 20 also includes threaded apertures 22 positioned at the lower end thereof extending fully therethrough. As discussed above, the lower end of the neck 20 is sized and shaped substantially similar to the cutout 18 of the body 10. The apertures 22 are sized and positioned to match the apertures 16 of the body 10. In these embodiments, four apertures 16, 22 are provided on each of the body 10 and neck 20, but one skilled the art would recognize that fewer apertures could be provided without departing from the spirit and scope of the invention. Furthermore, in these embodiments, the apertures 16, 22 include reinforced threaded steel to provide durability and to prevent damage to the body 10 and neck 22, which are constructed of wood. However, one skilled in the art would recognize that the threads could be provided on the wood directly or that other reinforcements such as plastic could be used.

Still to FIGS. 2 and 3, the body 10 and the neck 20 are securely coupled together by engaging threaded fasteners 24 through the respective apertures 16, 22. In this embodiment, the fasteners 24 are constructed of steel and include a flat head having an engagement means such as grooves. The grooves could be sized and shaped for a flat head or Phillips head screwdriver, or an Allen wrench with different sizes and shapes, e.g. hex key. As such, one of ordinary skill will recognize that the engagement means could take on multiple forms.

Referring to FIGS. 1-3, the guitar 1, 2 includes a headstock 30 extending from the neck 20. The headstock 30 includes six string ports 32 operably coupled to respective tuning keys 34 such that when a tuning key 34 is rotated, a corresponding string port 32 is rotated. In these embodiments, as shown in FIG. 1, each string port 32 includes an aperture 36 for receiving a guitar string 40. The guitar string 40 includes a loop 42 or ball end which is secured to the inside of the string port 32. In this embodiment, a channel 37 is provided above the aperture 36 to accommodate the ball end of the loop 42. As such, each guitar string 40 is secured to the guitar 1, 2 at a bridge pin 14 on one end and to a corresponding string port 32 on another end, and the string 40 is tuned with a corresponding tuning key 34. Also, the configuration of the loops 42 of the guitar strings 40 allows for the user to easily remove the guitar strings 40 from the string ports 32 when the guitar 1, 2 is collapsed. This configuration also allows for the user to re-use the strings 40 when re-assembling the guitar 1, 2.

Still referring to FIGS. 1-3, with respect to the headstock 30, in this embodiment, the headstock 30 includes six tuning keys 34 aligned in a row. However, one of ordinary skill will recognize that other configurations could be utilized without departing from the spirit and scope of the invention. For example, three tuning keys 34 could be positioned on each side of the headstock 30. Alternatively, four tuning keys 34 could be positioned on one side of the headstock 30 while two tuning keys 34 are positioned on an opposing side. The placement of the tuning keys 34 could be selected to vary other aspects of the guitar 1, 2 such as number of frets and overall length of the guitar 1, 2.

When the guitar 1, 2 is disassembled, as shown in FIGS. 2 and 3, the guitar strings 40 are removed from the string ports 32 on one end but not removed from the bridge pins 14. The body 10 and neck 20 are then removed from each other by disengaging the fasteners 24.

In the first embodiment, shown in FIGS. 1 and 2, the overall dimensions of the neck 20 and headstock 30 combined are such that it is capable of fitting in a case having dimensions of 21.9 inches in length, 13.75 inches in width and 4.25 inches in depth, as will be described in more detail below. The body 10 is dimensioned such that it is capable of fitting in a case having dimensions of 18 inches in length, 13.75 inches in width and 4.25 inches in depth, as will be described in more detail below.

In the second embodiment, shown in FIG. 3, the overall dimensions of the neck 20 and headstock 30 combined are such that it is capable of fitting in a case having dimensions of 33.9 inches in length, 13.75 inches in width and 5 inches in depth, as will be described in more detail below. The body 10 is dimensioned such that it is capable of fitting in a case having dimensions of 21.9 inches in length, 13.75 inches in width and 5 inches in depth, as will be described in more detail below.

One skilled in the art will recognize that the guitars 1, 2 could be configured to include as few as four strings and as many as twelve strings without departing from the sprit and scope of the present invention.

### Expandable Carrying Case or Bag

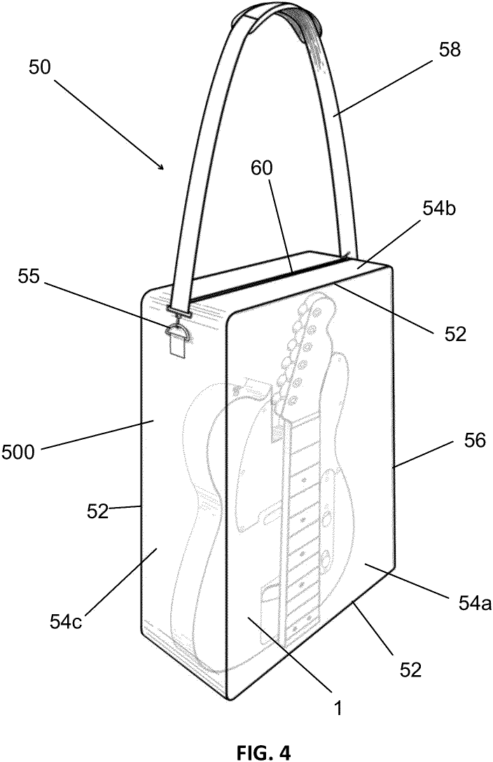

Referring to FIG. 4-10C, an embodiment of a carrying case or bag 50 of the present invention is shown. In general, as shown in FIGS. 4 and 5, the carrying case 50 includes a first compartment 500 that is six-sided, i.e., six walls 54a-f, forming an enclosed first space therein. The first compartment 500 includes a fastener 52 for extending along three edges of a front panel or wall 54a for opening and closing the same. A fourth edge 56 of the front panel 54a is hingedly coupled such that the front panel 54a rotatable about the fourth edge 56 when the front panel 54a is opened. In this embodiment, the fastener 52 is a zipper but other means could be used, such as buttons, hook-and-loop fasteners and the like. Also, the hinged coupling could be positioned on any of the four edges 52, 56 so long as the other edges are temporarily removable via the fastener 52. Moreover, one of ordinary skill in the art will recognize that the first compartment 500 could take on other shapes and sizes.

Referring to FIGS. 4 and 5, the interior of the first compartment 500 includes padded surfaces and/or liners for protecting the guitar 1, 2, or other objects and items from damage during storage and transport. Securing means are provided to secure the components of the guitar 1, 2 to the interior of the first compartment 500 and to prevent displacement during transport. The securing means could include straps with buckles or other attachment means such as hook-and-loop fasteners. A padded divider could also be provided so that the body 10 and neck 20 are separated and without contact to each other. Alternatively, the interior of the first compartment 500 could be provided with cavities for positioning the body 10 and neck 20 of the guitars 1, 2, or other objects therein. In this embodiment, the interior is constructed of a non-abrasive nylon liner with a thin protective nylon padding with closed cell foam. The exterior is constructed of a hard shell but other materials for both the interior liner and exterior could be used, such as leather, without departing from the spirit and scope of the invention.

Referring to FIGS. 4-9, the first compartment 500 also includes an opening 60 positioned on an upper side or wall 54b thereof for access to the interior of the first compartment 500. In this embodiment, the opening 60 is formed with a fastener, more specifically, a zipper, which can be opened and closed. Alternatively, other fasteners such as buttons, hook-and-loop fasteners and the like could be used. The exterior of the first compartment 500 is provided with a plurality of engagement members 55 on the side walls 54c and rear wall 54d for attaching straps 58, 66 to aid the user in transporting the carrying case 50. In this embodiment, the engagement members 55 are D-loops that are coupled to reinforcement members, which are stitched to the first and second compartments 500, 600, and the straps 58, 66 are provided with retractable hooks for attaching to the D-loops. However, other means known in the art could be used. In the alternative, the first compartment 500 could include wheels positioned at a lower portion thereof, along with a retractable handle at an upper portion thereof, so that the carrying case 50 could be rolled on a surface rather than the user having to carry the same.

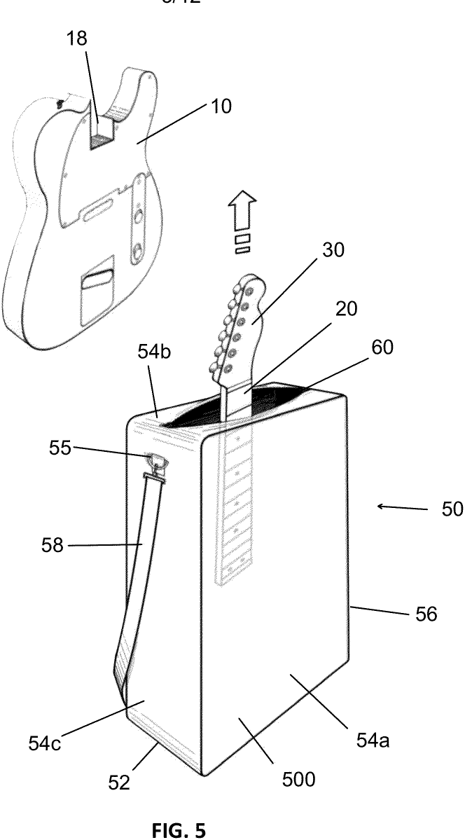

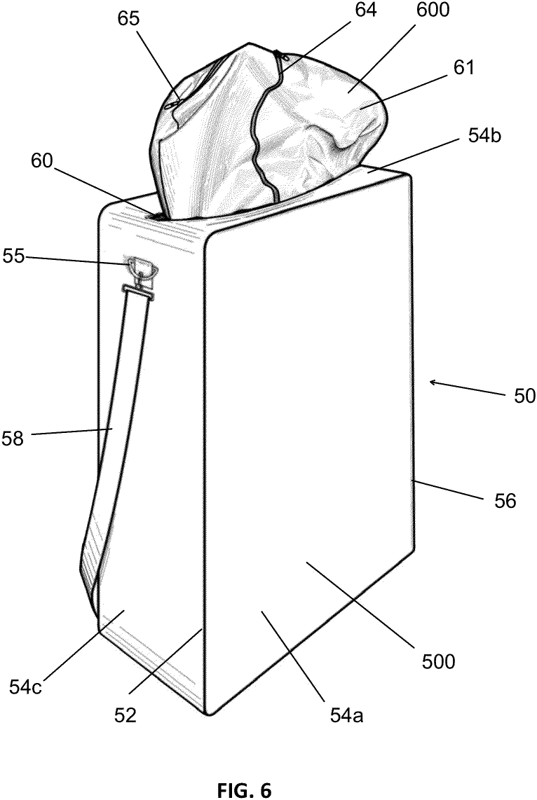

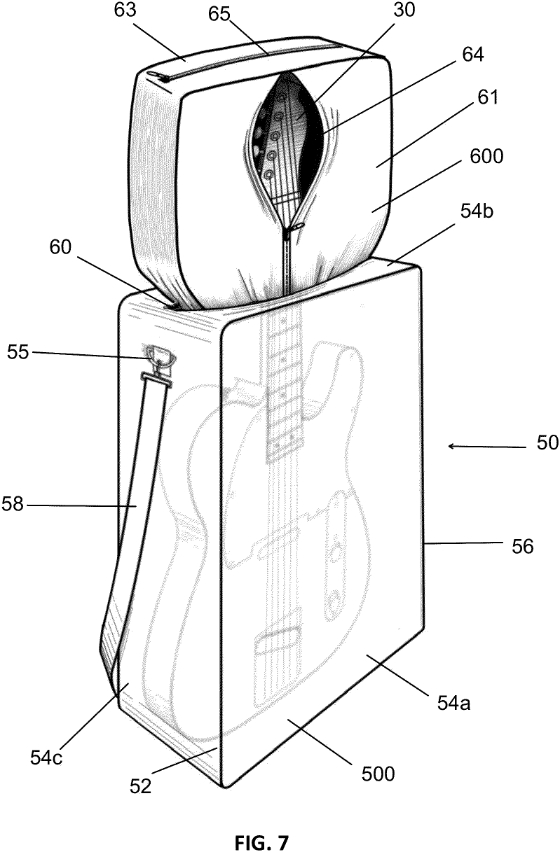

Referring to FIGS. 6-9, the expandable enclosure or second compartment 600, having a second space formed therein, is operably coupled with the first compartment 500, and includes a fastener 64 positioned on a front wall 61 thereof for opening and closing the same, as shown in FIGS. 7 and 8. Similarly, a top wall 63 includes a fastener 65 for opening and closing the same. In this embodiment, the fasteners 64, 65 are zippers configured to be opened to access the interior space of the second compartment 600, but other means could be used, such as buttons, hook-and-loop fasteners and the like. The second compartment 600 could be a quilted fabric padded with batting, i.e., fluffy fabric to pad a quilt, to provide a semi-rigid structure when expanded.

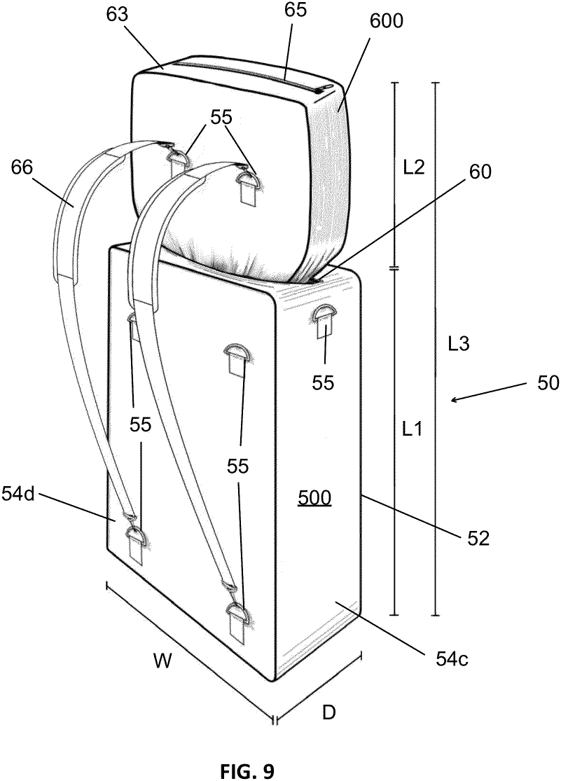

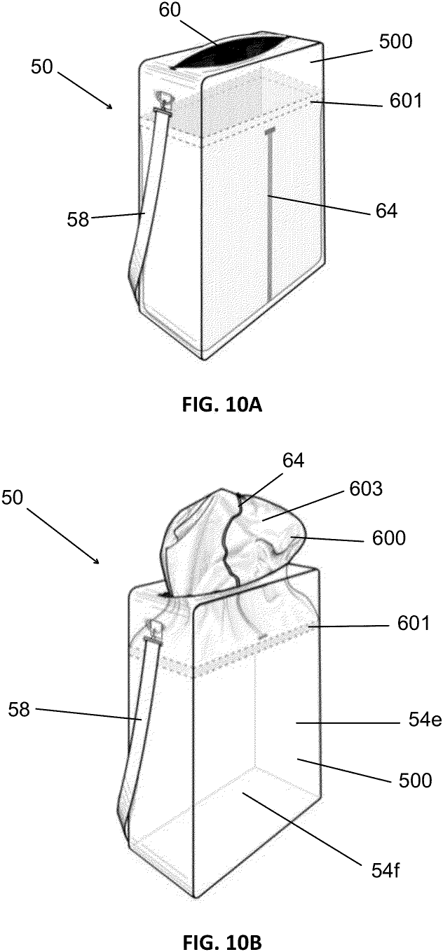

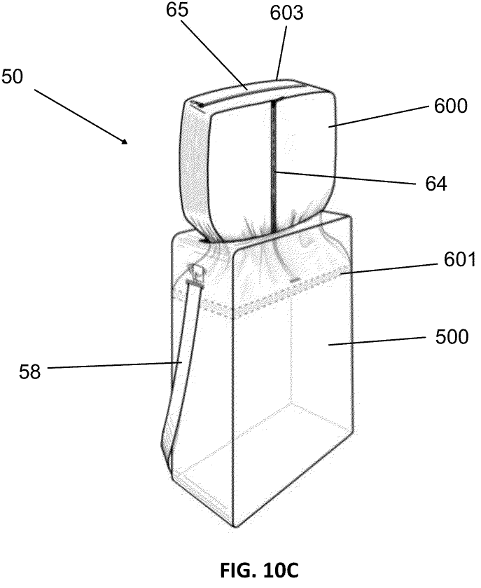

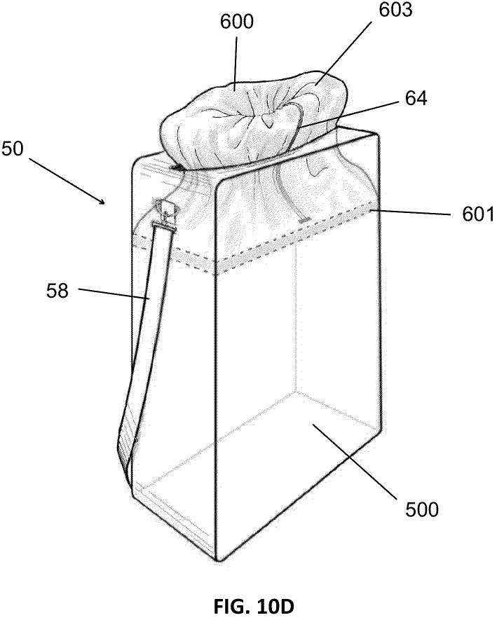

Referring to FIGS. 10A-10C, in this embodiment, the second compartment 600 includes a free end 601 and an opposing enclosed end 603. The circumference of a free end 601 of the second compartment 600 is substantially equal to the circumference of the interior of the first compartment 500, and the free end 601 is coupled thereto by conventional stitching methods. However, the free end 601 could be coupled to the interior of the first compartment 500 by other means such as buttons, hook-and-loop fasteners and the like. In this embodiment, the free end 601 is positioned at about the mid-point of the upper half of the first compartment 500, but the positioning of the free end 601 is not limiting. The enclosed end 603 is shaped and sized substantially the same as the interior of the first compartment 500, as shown in FIG. 10A. That is, when stored within the interior of the first compartment 500, the enclosed end 603 can be fitted directly against the first compartment walls 54a, c-f of the interior of the first compartment 500. However, the second compartment 600 could take on other shapes and sizes.

There are several methods of storing the second compartment 600 within the first compartment 500. In one example, as shown in FIG. 10A, the second compartment 600 is stored within the interior of the first compartment 500 with the outer surface of the enclosed end 603 facing inward. That is, the enclosed end 603 is inside-out. When stored, the fasteners 64, 65 can be opened or closed. In the event that the user wishes to access the interior of the first compartment 500 though the hinged front wall 54a, the second compartment 600 is stored with the front fastener 64 open. In a second example, if the second compartment 600 is sized such that the enclosed end 603 does not extend to the bottom wall/floor 54f when stored, the upper fastener 65 is opened so that the interior space of the first enclosure 500 is accessible unimpeded. In a third example, whether the second compartment 600 is sized and shaped similar to the interior of the first compartment 500, if the user wishes to quickly access the stored second compartment 600 through the first compartment opening/fastener 60 positioned on the top wall 54b, the second compartment 600 could be stored against the interior of the top wall 54b for easily removing the second compartment 600 from the first compartment 500 for expansion and use, as shown, for example, in FIGS. 10B and 10C.

As shown in FIG. 10B, when expanding the second compartment 600, the user engages the second compartment 600 through the opening 60 and pulls the same to the exterior of the first compartment 500. In this manner, the surfaces of second compartment 600 are reversed, i.e., the surface of the second compartment 600 facing the interior space of the first compartment 500 when stored (FIG. 10A) is exposed to the outside of the first compartment 500 (FIGS. 10B and 10C).

As shown in FIG. 10D, when the user wishes to store the second compartment 600 in the first compartment 500, the user pushes down on the enclosed end 603 and collapses the same. As described above, the second compartment 600 could be stored within the first compartment 500 in a variety of ways, including extending the entire enclosed end 603 of the second compartment 600 downward inside-out and overlapping the first and second compartments 500, 600, shown in FIG. 10A.

In an alternative embodiment, the second compartment 600 could be provided with a removable floor so that the opening 60 is covered when the second compartment 600 is expanded. In this manner, the second compartment 600 is used as a separate enclosure for storing items that the user wishes to quickly access, such as wallets, keys, purses, passports, make-up, beverages, hand-held devices, etc. through the openings/fasteners 64, 65.

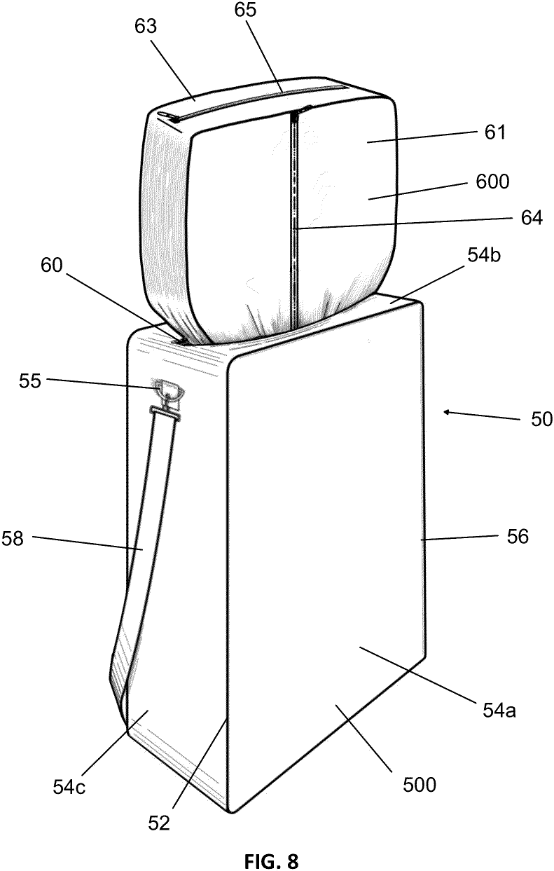

As shown in FIG. 9, in this embodiment, the first compartment 500 has a length L1 of 21.9 inches, a width W1 of 13.75 inches and a depth D1 of 5 inches. The second compartment, in an expanded state, has a length L2 of 12 inches, and a width and depth with similar dimensions as the first compartment 500. As a result the total length L3 of the carrying case 50 is 33.9 inches.

As shown in FIGS. 4 and 5, in one aspect, the carrying case 50 is configured to accommodate the guitar of the first embodiment 1 in the disassembled or collapsed state, without use of the second compartment 600, such that the carrying case 50 is capable of carrying onto a commercial airplane. When used in this manner, a single shoulder strap 58, as shown in FIG. 4, could be used, or double shoulder straps 66 (see FIG. 9) could be attached to the rear wall 54d via four D-loops 55 and carried on the user’s back. The guitar 1 can be quickly accessed through the top opening 60 if necessary.

As shown in FIGS. 6-9, in another aspect, the carrying case 50 is configured to accommodate the guitars of the first and second embodiment 1, 2 in assembled states. In this instance, the expandable enclosure or second compartment 600 is utilized to accommodate the neck of the guitar 1. When used in this manner, the pair of shoulder straps 66 could be coupled either to the first compartment 500 or both the first and second compartments 500, 600, as shown in FIG. 9, to further aid the user in transporting the carrying case 50.

The carrying case 50 could be a soft shell case that acts as a “gig bag.” That is, the intended purpose of the carrying case 50 is to provide the user with a light-weight yet durable case or bag for quickly storing and transporting guitars 1, 2 or other items. The carrying case 50 of the present invention could also include a hard outer shell and a padded interior for protecting the stored guitar during storage and transport. As discussed above, additional securing means could be provided in the interior to prevent the guitar or other items and objects from displacement during transport.

In other embodiments, the carrying case 50 could be constructed with the expandable enclosure or second compartment 600 having a greater length/height to accommodate other assembled traditional sized guitars and/or other collapsible traditional sized guitars, as well as other items or objects that are longer than usual.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1. An expandable carrying case comprising:
a first compartment having:
a plurality of first walls forming a first space therebetween; and
a first opening positioned on one of the plurality of first walls, the first opening configured to be opened for access to the first space, and configured to be closed to enclose the first space; and
a second compartment coupled to the first compartment and configured to be stored within the first compartment to a stored state, and configured to extend from the first compartment to an extended state, the second compartment having:
a plurality of second walls forming a second space therebetween; and
a second opening positioned on one of the plurality of second walls, the second opening configured to be opened for access to the second space, and configured to be closed, the first and second openings being substantially aligned with each other;
wherein in the extended state, the second compartment extends through the first opening, and the first and second spaces are adjacent to each other thereby forming a collective third space, the third space being enclosed when the second opening is closed; and
wherein in the stored state, the second space is positioned within the first space, the second space at least partially coinciding with the first space such that an object is free to move within the first and second spaces and through the first opening.

2. The carrying case of claim 1, wherein in the extended state, the second space is formed between inner sides of the plurality of second walls.

3. The carrying case of claim 1, wherein in the stored state, the second space is formed between outer sides of the plurality of second walls.

4. The carrying case of claim 1, wherein at least one of the first and second openings comprises a fastener for opening and closing the opening.

5. The carrying case of claim 4, wherein the fastener is a zipper.

6. The carrying case of claim 1, further comprising a third opening positioned on another one of the plurality of second walls, the third opening configured to be opened and closed.

7. An expandable carrying case comprising:
a first compartment having:
a plurality of first walls forming a first space therebetween; and
a first opening positioned on one of the plurality of first walls, the first opening configured to be opened for access to the first space, and configured to be closed to enclose the first space; and
a second compartment coupled to the first compartment and configured to be stored within the first compartment to a stored state, and configured to extend from the first compartment to an extended state, the second compartment having:
a plurality of second walls forming a second space therebetween; and
a second opening positioned on one of the plurality of second walls, the second opening configured to be opened for access to the second space, and configured to be closed;
wherein in the extended state, the second compartment extends through the first opening, and the first and second spaces are adjacent to each other thereby forming a collective third space, the third space being enclosed when the second opening is closed; and
wherein in the stored state, the second space is positioned within the first space.

8. The carrying case of claim 7, wherein in the stored state, the second space at least partially coincides with the first space such that an object is free to move within the first and second spaces and through the first opening.

9. The carrying case of claim 7, wherein in the extended state, the second space is formed between inner sides of the plurality of second walls.

10. The carrying case of claim 7, wherein in the stored state, the second space is formed between outer sides of the plurality of second walls.

11. The carrying case of claim 7, wherein the first and second openings are substantially aligned with each other.

12. The carrying case of claim 7, further comprising a third opening positioned on one of another one of the plurality of first walls and another one of the plurality of second walls, the third opening configured to be opened and closed.

13. The carrying case of claim 7, wherein at least one of the first and second openings comprises a fastener for opening and closing the opening.

14. An expandable carrying case comprising:
a first compartment having:
a plurality of first walls forming a first space therebetween; and
a first opening positioned on one of the plurality of first walls, the first opening configured to be opened for access to the first space, and configured to be closed to enclose the first space; and
a second compartment coupled to the first compartment and configured to be stored within the first compartment to a stored state, and configured to extend from the first compartment to an extended state, the second compartment having:
a plurality of second walls forming a second space therebetween; and
a second opening positioned on one of the plurality of second walls, the second opening configured to be opened for access to the second space, and configured to be closed.

15. The carrying case of claim 14, wherein in the extended state, the second compartment extends through the first opening, the first and second spaces are adjacent to each other thereby forming a collective third space, the third space being enclosed when the second opening is closed.

16. The carrying case of claim 14, wherein in the stored state, the second space is positioned within the first space and formed between outer sides of the plurality of second walls.

17. The carrying case of claim 16, wherein the second space at least partially coincides with the first space such that an object is free to move within the first and second spaces, and through the first and second openings.

18. The carrying case of claim 14, wherein the first and second openings are substantially aligned with each other.

19. The carrying case of claim 14, wherein at least one of the first and second openings comprises a fastener for opening and closing the opening.

20. The carrying case of claim 14, further comprising a third opening positioned on another one of the plurality of second walls, the third opening configured to be opened and closed.
